(19) United States
(12) Patent Application Publication
(10) Pub. No.: US 2022/0387954 A1
(43) Pub. Date: Dec. 8, 2022

(54) Method for operating a descending moving bed reactor with flowable granular material

(71) Applicants: BASF SE, Ludwigshafen am Rhein (DE); thyssenkrupp AG, Essen (DE); thyssenkrupp Industrial Solutions AG, Essen (DE)

(72) Inventors: Grigorios Kolios, Ludwigshafen (DE); Frederik Scheiff, Ludwigshafen (DE); Christopher Alec Anderlohr, Ludwigshafen (DE); Hagen Appel, Ludwigshafen (DE); Gerhard Olbert, Ludwigshafen (DE); Bernd Zoels, Ludwigshafen (DE); Dieter Flick, Ludwigshafen (DE); Achim Wechsung, Ludwigshafen (DE); Matthias Kern, Ludwigshafen (DE); Karsten Bueker, Dortmund (DE); Nicolai Antweiler, Essen (DE)

(73) Assignees: BASF SE, Ludwigshafen am Rhein (DE); thyssenkrupp AG, Essen (DE); thyssenkrupp Industrial Solutions AG, Essen (DE)

(21) Appl. No.: 17/755,333

(22) PCT Filed: Oct. 20, 2020
(86) PCT No.: PCT/EP2020/079419

§ 371 Date: Apr. 27, 2022

(30) Foreign Application Priority Data
Oct. 31, 2019 (EP) 19206409.5

(51) Int. Cl. B01J 8/12; B01J 8/00; C01B 3/30

(52) U.S. Cl. CPC B01J 8/12; B01J 8/0015; C01B 3/30; C01B 2203/0272; C01B 2203/1241

(57) ABSTRACT

A method can be used for operating a descending moving bed reactor with flowable granular material. The method involves: (i) filling an upper lock-hopper with granular material and/or emptying a lower lock-hopper, (ii) purging the lock-hoppers with purging gas, and (iii) filling the reaction chamber containing a descending moving bed from the upper lock-hopper and/or emptying the reaction chamber into the lower lock-hopper. The pressure equalization between the reaction chamber and lock-hopper is achieved with product gas. The method then involves: (iv) optionally, relieving the lock-hoppers and conveying the product gas flow into the product line, and (v) purging the lock-hoppers with purging gas.

The present invention relates to a method for operating a descending moving bed reactor with flowable granular material, said method comprising the steps of (i) Filling a upper lock-hopper with granular material and/or emptying a lower lock-hopper, (ii) Purging the lock-hoppers with purge gas, (iii) Filling the reaction chamber comprising a descending moving bed from the upper lock-hopper and/or emptying the reaction chamber into the lower lock-hopper, wherein the pressure equalization between the reaction chamber and lock-hopper is achieved with product gas, (iv) Optionally relieving the lock-hoppers and conveying the product gas flow into the product line and (v) Purging the lock-hoppers with purge gas.

When filling a solid material, e.g. carrier, into a reaction chamber and when removing the solid product from the reaction chamber, the differences in atmosphere and pressure between the reaction chamber and the environment must be adapted. Pressure fluctuations caused by the solid transfer are often the reason of fluctuating product compositions.

According to the state of the art, solid transfer is realized by infeed and outfeed locks, e.g. lock-hoppers [Mills, David. Pneumatic conveying design guide (Third Edition). Elsevier, 2016]. The lock-hopper arrangement consists of three vessels arranged in a row and lockable against each other.

Schingnitz et al., Fuel Processing Technology, Volume 16, Issue 3, June 1987, Pages 289-302, describes a pressure gasification process of lignite. Pulverized coal is fed to a storage bin via pneumatic conveying. The transport gas leaves the system through a filter. The two pressurized lock chambers are alternately loaded to pressurize the pulverized coal up to 4 MPa. Subsequently the pulverized coal is passed into a feeder via pipes and a pressurized star feeder. Through the alternate operation of the pressurized lock chambers the feeder can be fed continuously. By means of the transport gas the fluidized pulverized coal is supplied into a delivery pipe at high density and passed on to the gasification reactor burner. Applying this high-density conveying process, the pulverized coal loading of the transport gas can be as high as 500 kg/m³. According to the authors, the high-density conveying process reduces the gas consumption compared to the conventional low-density conveying process by two orders of magnitude. However, nothing is mentioned on the gas consumption associated with purging and pressure equalization of the lock chambers. The disadvantage of this state of the art is, that the purge gas is lost after a single passage through the lock chambers.

CN 106 893 611 describes an equipment for a coal gasification comprising a reactor vessel with an upper and lower lock-hopper. The upper lock-hopper comprises two equalizer valves, a pipeline equalizer valve for the pressure equalization and for the change in atmospheres and a secondary equalizer valve which is connected to the reaction chamber for the fine adjustment of the pressure.

KR 100 742 272 discloses a feed system for an entrained flow gasifier comprising a storage tank to purge the lock vessel and a recirculation line that transports the vent gas to the distribution hopper.

These two inventions rely on the use of inert gases at elevated pressure for purging the lock-hoppers. In both inventions the pressurized inert gas is utilized for bridging the pressure difference between the storage hopper and the process reaction chamber. The disadvantage of this state of the art is that the compression of the purging gas requires considerable power and inert gas consumption.

U.S. Pat. No. 3,775,071 discloses a series of upper lock-hoppers that are vented with pressurized process stream, wherein the process stream is stored in a surge drum and is recycled. The aim of this invention is to minimize the losses of process gas in the solid feed line. The invention relies on the barrier effect of the screw feeders to prevent back-flow of gas forced by the pressure gradient against the flow direction of the solid feed. The disadvantage of this state of the art is that no measures are provided to exclude breakthrough of the pressurized process gas into the atmospheric coal hopper and the formation of a flammable gas mixture.

In addition, DD 147188 A3 describes a method for minimizing the gas consumption of carrier gas for the pneumatic conveyance of a solid flow into a reaction chamber. The pressurized lock container is loaded with carrier gas being air, process gas or inert gas. The intended reduction of the carrier gas consumption results from the use of a separate inert gas for pressurizing the locks, that will be discharged directly after a single passage. Although the value of inert gas is rated negligible, the large amount and the compression power required to pressurize the lock-hoppers turns out to be a severe disadvantage of this disclosure.

Guo et al., Fuel Processing Technology, Volume 88, Issue 5, May 2007, Pages 451-459 describes a process flow of a coal gasifier. The feeding system consists of an atmosphere hopper, a lock-hopper and a feed-hopper. Pulverized coal in the atmosphere hopper is transferred via the lock-hopper to the pressurized feed-hopper. Nitrogen or carbon dioxide were used as carrier gas and as purge gas. The vent gas from the hopper is released to the atmosphere through a coal filter. However, nothing is mentioned on the gas losses associated with purging and pressure equalization of the lock chambers.

U.S. Pat. No. 4,955,989 describes the use of lock-hopper with pressurized inert gas and pressure vessels with a pressurized CO/H2 mixture. The gas exchange between the lock-hopper and the pressure vessel can be minimized by using a small pressure difference. The solid particles in the lock-hopper and the pressure vessel form a fluidized bed. Nitrogen and CO/H2 can both used as fluidizing gas and carrier gas for solids transport. The problem of gas loss, in particular of CO/H2, is addressed by the use of inert gas for pressurizing and fluidizing the content of the lock-hopper. However, the large amount and the compression power required cause a severe disadvantage to this disclosure.

U.S. Pat. No. 8,790,048 discloses a feeding system comprising two parallel lock-hoppers. Top of the lock-hoppers is connected to a granular substance entrance pipe via an interposed entrance valve. Respectively, their bottom is connected to a granular substance exit pipe via an interposed exit valve. Further they are connected to a gas-introducing pipe via an interposed gas-introducing valve. The state of operation of the lock-hoppers is switched alternated and repeatedly among two stages:
1) A state where the inlet valve of the lock-hopper is open whereas the exit valve and the gas-introducing valve are closed. During this stage the lock-hopper receives granular substance from the upper system and gas flows in exchange from the hopper to the upper system.
2) A state where the inlet valve of the lock-hopper is closed whereas the exit valve and the gas-introducing valve are open. During this stage the granular substance is discharged from the lock-hopper to a lower system. A volume of gas, equal to 1 to 2 times the volume of the discharged granular substance is introduced to the lock-hopper.

The purpose of the invention is to ensure a large and uniform transfer rate of solid particles independently from particle size. A disadvantage of this state of the art is that the gas volume flushed to the upper system during charging the lock-hopper is lost. Further, a disadvantage of this state of the art occurs, when the lower system is at higher pressure compared to the upper system. For example, this is the case when granular coal is fed from an atmosphere storage bin to a pressurized gasification reactor. In this case the granular particles are forced to flow against the pressure gradient. This may hinder the flow of granular substances that is forced by gravitation. Further, a disadvantage of this state of the art is, that it cannot exclude that gases originating from the upper and from the lower system may mix in the lock-hopper. In some applications it may cause the formation of flammable mixtures.

US 2018/0022556 discloses a method for transferring solid material from an atmosphere storage bin to a pressurized process chamber. The method comprises the following steps:
a) Providing material to a first lock-hopper;
b) closing a valve coupled to an inlet of the first lock-hopper;
c) providing fluid to pressurize the first lock-hopper;
d) opening a valve at the outlet of the first lock-hopper;
e) releasing the pressurized content comprising fluid and solid feed material into a circulation loop;
f) providing solid feed material to a second lock-hopper;
g) closing a valve coupled to an inlet of the second lock-hopper;
h) providing fluid to pressurize the second lock-hopper;
i) opening a valve at the outlet of the second lock-hopper;
j) releasing the pressurized content comprising fluid and solid feed material into a circulation loop;
k) providing the pressurized content of the circulation loop to a first receiving unit;
l) providing fluid from the receiving unit to the circulation loop;
m) closing the valve at the outlet of the first lock-hopper;
n) releasing fluid from the first lock-hopper to a containment unit to depressurize the first lock-hopper;
o) closing the valve at the outlet of the second lock-hopper;
p) releasing fluid from the second lock-hopper to a containment unit to depressurize the second lock-hopper.

A disadvantage of this state of the art is, that a particular fluid circuit is required for pressurizing the content of the lock-hopper and for transferring the solid material from the lock-hoppers to the receiving units. Another disadvantage is, that the optional use of a liquid as a pressurizing and carrier fluid is restricted to applications, where wetting the solid material is benign to the process. A disadvantage of this state of the art is, that during depressurization the compressed gas is directly released to the environment.

U.S. Pat. No. 3,873,441 discloses a process for withdrawing and replenishing solid catalyst in a moving-bed reactor. The invention applies preferably to liquid-phase hydroprocessing. The process comprises the following steps:
a) Passing spent catalyst downward from the moving-bed reaction zone into a collection hopper.
b) Passing a sealing liquid hydrocarbon stream upward into the reaction zone at a rate sufficient to prevent further passage of catalyst downwards,
c) Equalizing the pressure among the catalyst hopper and a liquid filled lock-hopper and opening the sealing valve in the transfer conduit between the catalyst hopper and the lock-hopper, thus transferring the catalyst from the catalyst hopper into the lock-hopper,
d) Closing the sealing valve in the conduit between the catalyst hopper and the lock-hopper, thus isolating the lock-hopper,
e) Reducing the flow rate of the sealing liquid stream to effect the passage of additional catalyst into the catalyst hopper.

The disadvantage of this state of the art is that the descent of the packing happens compulsorily batch-wise. Another disadvantage is, that the applicability of the invention is restricted to liquid-phase reactions. Another disadvantage is, that the liquid reactor effluent is contaminated by the sealing liquid. Another disadvantage is that measures for reclaiming the sealing liquid are missing.

If the reaction product is, for example, a synthesis gas for the subsequent use in various chemical syntheses, the purging/pressuring gas content, e.g. nitrogen, in the synthesis gas is extremely undesirable and is usually limited to a specific value that depends on the respective synthesis. As a result, the purification of the diluted gaseous product is more expensive. In addition, the cost for the nitrogen burdens the economic efficiency of the process. Finally, when the lock-hopper is emptied, product gas is discharged, which reduces the product yield.

The present invention is thus based on the task of reducing the consumption of purge gas, mostly nitrogen, when using infeed and outfeed locks like lock-hoppers. Furthermore, it is a task to exclude formation of flammable gas mixtures that could form by uncontrolled contact of gas from the reaction chamber with the ambient atmosphere. Furthermore, it is a task to minimize product losses using lock-hoppers. Furthermore, it is a task to minimize the contamination of the product flow by purge gas, mostly nitrogen.

Surprisingly, an improved method for operating a descending bed, preferable a descending moving bed, reactor with flowable granular material was found, said method comprising the steps of:
(i) Filling at least one upper lock-hopper with granular material and emptying at least one lower lock-hopper, wherein the solid transfer is conducted synchronously or offset to each other in time,
(ii) Flushing at least one lock-hopper with purge gas and recirculating at least part of the purge gas in a purge gas circuit fed from a purge gas storage tank and recirculated to this tank, wherein the flushing of the different lock-hoppers is conducted synchronously or offset, wherein the effluent gas comprising a high concentration of oxygen is discharged in a first step (ii-a) and the purge gas comprising a low concentration of oxygen gas is recirculated in a purge gas circuit fed from a purge gas storage tank in a second step (ii-b)
(iii) Filling the reaction chamber comprising a descending moving bed from the at least one upper lock-hopper and optionally emptying the reaction chamber into the at least one lower lock-hopper, wherein the solid transfer is conducted synchronously or offset to each other in time and wherein the pressure equalization between the reaction chamber and the lock-hoppers is achieved with gas taken from the head space of the reactor chamber, wherein the pressure equalization is conducted synchronously or offset in time to the filling/emptying of the reaction chamber,
(iv) Optionally relieving pressure of the lock-hoppers and conveying the product gas flow from the lock-hoppers into a main product line that connects a gas outlet of the reaction chamber with downstream units and
(v) Flushing the lock-hoppers with purge gas and recirculating at least part of the purge gas in a purge gas circuit fed from a purge gas storage tank and recirculated to this tank or flushing the lock-hoppers with purge gas into the product line or discharging the effluent stream.

In other words, an improved method for operating a descending bed, preferable a descending moving bed, reactor with flowable granular material was found, said method comprising the following steps in the upper lock-hoppers:
(i) filling at least one lock-hopper with granular material,
(ii) flushing at least one lock-hopper with purge gas and recirculating at least part of the purge gas in a purge gas circuit fed from a purge gas storage tank and recirculated to this tank, wherein the effluent gas comprising a high concentration of oxygen is discharged in a first step (ii-a) and the purge gas comprising a low concentration of oxygen gas is recirculated in a purge gas circuit fed from a purge gas storage tank in a second step (ii-b)
(iii) filling a reaction chamber comprising a descending moving bed from the at least one upper lock-hopper, wherein the pressure equalization between the reaction chamber and the lock-hoppers is achieved with gas taken from the head space of the reactor chamber,
(iv) optionally relieving pressure of the upper lock-hoppers and conveying the product gas flow from the upper lock-hoppers into a main product line that connects a gas outlet of the reaction chamber with downstream units and,
(v) flushing the lock-hoppers with purge gas and recirculating at least part of the purge gas in a purge gas circuit fed from a purge gas storage tank and recirculated to this tank or flushing the lock-hoppers with purge gas into the product line or discharging the effluent stream.
   and the following steps in the lower lock-hoppers:
(i) emptying the granular material from at least one lock-hopper,
(ii) flushing at least one lock-hopper with purge gas and recirculating at least part of the purge gas in a purge gas circuit fed from a purge gas storage tank and recirculated to this tank, wherein the effluent gas comprising a high concentration of oxygen is discharged in a first step (ii-a) and the purge gas comprising a low concentration of oxygen gas is recirculated in a purge gas circuit fed from a purge gas storage tank in a second step (ii-b)
(iii) emptying a reaction chamber into the at least one lock-hopper, wherein the pressure equalization between the reaction chamber and the lock-hoppers is achieved with gas taken from the head space of the reactor chamber,
(iv) optionally relieving pressure of the lock-hoppers and conveying the product gas flow from the lock-hoppers into a main product line that connects a gas outlet of the reaction chamber with downstream units and
(v) flushing the lock-hoppers with purge gas and recirculating at least part of the purge gas in a purge gas circuit fed from a purge gas storage tank and recirculated to this tank or flushing the lock-hoppers with purge gas into the product line or discharging the effluent stream,
   wherein the corresponding steps of the cycle are conducted synchronously or offset to each other in time in the upper lock-hoppers and in the lower lock-hoppers.

The reaction chamber of the invention is that part of the system that can favorably be permanently exposed to the reactive atmosphere during its intentional use. The above procedure applies advantageously to the regular operation state of the process, meaning that the reaction chamber is filled with the solid (pre-existing bed) and the fluid reaction media, pressure and temperature are within the range required for achieving the target conversion of the reaction.

The reactor section of the invention is advantageously a packed reactor comprising a random bed of solid particles, preferable a descending moving bed reactor, at an appropriate temperature level for conducting the desired chemical reactions.

The method of the present invention can preferably transfer granular material from a low pressure zone at typically ambient pressure to a high pressure zone of up to 100 bar and back to a low pressure zone at typically ambient pressure.

Preferably, the present method is conducted in a cyclic operation; that means step (i) will preferably follow step (v). The volumetric capacity of the lock-hoppers, reaction chamber, storage hoppers, the filling/emptying rate etc. depend on the specific granular material and the conducted reactions and can be adapted by a skilled person in the art. Thus, the cycle period in the upper lock-hoppers and in the lower lock-hoppers might differ from each other. Advantageously the cycle period of one operation cycle of the upper lock-hoppers is equal to one tenth to ten cycle periods of the operation cycle of the lower lock-hoppers (0.1:1 to 10:1), preferably the cycle period of one operation cycle of the upper lock-hoppers is equal to one third to three periods of the operation cycle of the lower lock-hoppers (0.3:1 to 3:1).

Preferably the operation cycle of the step (ii) and/or step (v) of the upper and lower lock-hoppers overlap in time.

Advantageously the operation cycle of the steps (i), (iii) and/or (iv) of the upper lock-hoppers and the operation cycle of the lower lock-hoppers are independent from each other in time.

Preferably, the present method is conducted parallel to a reaction taken place in the reaction section. Preferred reactions are mentioned below.

Lock-Hoppers:

If the reaction taken place in the reaction section (10) is conducted in a continuous manner, preferably at least two upper and/or at least two lower lock-hoppers are used.

In principle, the following combinations of lock-hoppers are preferable:
one upper lock-hopper (20) and one lower lock-hopper (30), all outside the reaction chamber (10)
two upper lock-hoppers (20) in parallel and one lower-lock-hopper (30), all outside the reaction chamber (10)
one upper lock-hopper (20) and two lower lock-hoppers in parallel (30), all outside the reaction chamber (10)
two upper lock-hoppers (20) and two lower lock-hoppers (30) both in parallel, all outside the reaction chamber (10).

The volume of each lock-hopper is favorably 10 liters to 1000 m³, preferably 100 liters to 100 m³, more preferably 500 liters to 50 m³. The filling level of each lock-hopper is favorably 0.1 meter to 50 meters, preferably 0.2 meter to 20 meters, more preferably 0.5 meter to 10 meters.

The absolute pressure of the reaction chamber (10) is favorably 0.1 bar to 100 bar, preferably 1 bar to 50 bar, more preferably from 1 bar to 25 bar.

The pressure ratio between the reaction chamber (10) and the carrier storage hopper (21) is favorably 0.1 to 100, preferably 1 to 50, more preferably 1 to 25. The pressure ratio between the reaction chamber and the solid product collection hopper (31) is favorably 0.1 to 100, preferably 1 to 50, more preferably 1 to 25.

The cycle time comprising steps (i) to (v) is 1 minute to 500 hours, preferably 2 minutes to 200 hours, more preferably 10 minutes to 100 hours, most preferably 20 minutes to 50 hours. The duration of step (i) is favorably from 0.5 minutes to 250 hours, preferably 1 minute to 100 hours, more preferably 5 minutes to 50 hours. The duration of step (ii) is favorably 1 second to 5 hours, preferably 2 seconds to 2 hours, more preferably 5 seconds to 1 hour. The duration of step (iii) is favorably 0.5 minute to 400 hours, preferably 1 minute to 200 hours, more preferably 5 minutes to 100 hours. The duration of step (iv) is favorably 1 second to 5 hours, preferably 2 seconds to 2 hours, more preferably 5 seconds to 1 hour. The duration of step (v) is favorably 1 second to 5 hours, preferably 2 seconds to 2 hours, more preferably 5 seconds to 1 hour.

The throughput rate of solid particles during step (i) is favorably 100 g/h to 500 tn/h, preferably 200 g/h to 200 tn/h, more preferably 500 g/h to 100 tn/h, most preferably 1000 g/h to 50 tn/h.

The pressure in the purge gas storage tank (50) is favorably 1.5 bar to 200 bar, preferably 2 bar to 50 bar, more preferably 3 bar to 10 bar.

The volumetric capacity of the lock-hopper (20, 30) is favorably 1% to 300% of the volumetric capacity of the reaction chamber (10), preferably 5% to 100% of the volumetric capacity of the reaction chamber (10), more preferably 10% to 70% of the volumetric capacity of the reaction chamber (10).

The volume of the purge gas storage tank (50) is favorably 0.1 m³ to 1000 m³, preferably 1 m³ to 100 m³, more preferably 5 m³ to 50 m³. The volumetric capacity of the purge gas storage tank is favorably 10% to 1000% of the volumetric capacity of the lock-hopper, preferably 50% to 500% of the volumetric capacity of the lock-hopper, more preferably 100% to 300% of the volumetric capacity of the lock-hopper (20, 30).

The purge gas comprises at least one of the group of nitrogen, helium, argon, carbon dioxide, steam.

The absolute pressure in the purge gas storage tank (50) is favorably 1.5 bar to 200 bar, preferably 2 bar to 50 bar, more preferably 3 bar to 20 bar.

The pressure ratio between the reaction chamber (10) and the purge gas storage tank (50) is favorably 0.1 to 100, preferably 1 to 50, more preferably 1 to 25.

The mass of the purge gas stored in the purge gas storage tank (50) is favorably 1 time to 200 times the gas hold up of the lock-hoppers (20, 30) during the purging step (step ii), preferably 2 times to 100 times, more preferably 5 times to 50 times.

Further design parameters of the lock-hoppers (shape, connections to vessels and conduits for gas and granular material, shut-off facilities, build-ins: the gas inlet and gas outlet manifolds, flow baffles, flow pattern and flow velocity, instruments and actuators, e.g. shut-off facilities, metering facilities, controlling facilities for flow rate, pressure, composition) are known to those skilled in the art.

Connections:

The present invention also includes a system comprising:

a carrier storage hopper (21) to deliver feed solids to at least one upper lock-hopper, the at least one upper lock-hopper comprising an inlet shut-off facility (23) and an outlet shut-off facility (22), e.g. a valve,

an upper granular material feeder (24) from at least one upper lock-hopper to the reaction chamber,

a reaction chamber (10) comprising a reaction section (101) and optionally an upper carrier hopper (102) and a lower product hopper (103) and additional facilities for a granular material recycle (106),

a lower granular material feeder (34) from the reaction chamber to the at least one lower lock-hopper (30),

an at least one lower lock-hopper (30) comprising an inlet shut-off facility (32) and an outlet shut-off facility (33), e.g. a valve,

a solid product collection hopper (31),

a circulation line (201) outside the reaction chamber in fluid communication with the lock-hoppers (20, 30) and the storage tank (50),

a purge gas storage tank (50) connected to the circulation line (201).

The at least one upper lock-hopper (20) is favorably connected to the carrier storage hopper (21) on one side and to the reaction chamber on the other side (10). Favorably, the connecting lines comprise a shut-off facility (22, 23). The shut-off facility can be, but not restricted to, at least one rotary valve, slide-gate valve, ball valve, plug valve or a combination of them. Optionally, the connecting line between the carrier storage hopper (21) and the at least one upper lock-hopper (20) comprises a metering feeder. Optionally, the connecting line between the at least one upper lock-hopper and the reaction chamber comprises a metering feeder 24).

The at least one lower lock-hopper (30) is favorably connected to the reaction chamber (10) on one side and to the product collection hopper (31) on the other side. Favorably, each of the connection lines comprise a shut-off facility (32, 33). The shut-off facility can be, but not restricted to, at least one rotary valve, gate valve, plug valve or a combination of them. Optionally, the connecting line between the reaction chamber and the at least one lower lock-hopper comprises a metering feeder (34). Optionally, the connecting line between the at least one lower lock-hopper and the product collection hopper comprises a metering feeder.

Favorably, the lock-hoppers are connected to the purge gas storage tank via individual inlet lines (202a, 202b) and recirculation lines (201). The inlet line and the recirculation line form a circuit allows to circulate purge gas between the storage tank and the lock-hopper. Each line comprises a shut-off facility, favorably ball valves, poppet valves, needle valves, piston valves. Optionally, the circuit comprises conveying facilities (60), dust separation facilities (61), pressure-controlling facilities (62, 63), flow-controlling facilities (64, 66, 68), gas analyzing facilities (65, 67). The execution of these facilities is known to those skilled in the art. The lock-hoppers are connected via individual equalization lines to the head space of the reaction chamber, favorably. Each equalization line comprises a shut-off facility (52a, 52b), favorably ball valves, poppet valves, needle valves, piston valves. Optionally, each equalization line comprises a flow restrictor and/or a flow controller and/or a pressure controller. The implementation of these facilities is known to those skilled in the art.

Optionally the reaction chamber (10) comprises at least an upper carrier hopper (102) and at least a lower product hopper (103). The upper carrier hopper can preferably be connected to the at least one upper lock-hopper (20) in serial or in parallel. The carrier hopper can be preferably be connected to a facility of recycling granular material (106). Favorably, the connecting line to the at least one upper lock-hopper comprises a shut-off facility (22). Optionally, the connecting line between the at least one upper lock-hopper and the carrier hopper comprises a metering feeder (24).

The lower product hopper (103) can be preferably connected to the at least one lower lock-hopper (30) in serial or in parallel. The product hopper can be preferably connected to a facility of recycling granular material (106). Thus, preferably, part of the granular material is recirculated from the lower product hopper (103) to the upper carrier hopper (102). Favorably, the connecting line to the at least one lower lock-hopper comprises a shut-off facility (32). Optionally, the connecting line between the at least one lower lock-hopper (30) and the product hopper (103) comprises a metering feeder (34).

Below, the method steps are described in detail and shown as a schematic operation mode in the figures. In view of the upper and lower lock-hoppers, one or two lock-hoppers can be used preferably, even if mentioned in a singular wording in the following section.

Method Step (i):

In the first step, the connecting line between the carrier storage hopper (21) and at least one upper lock-hopper (20) is opened and optionally at least one upper lock-hopper is filled with granular material. Preferred granular materials are described below. Optionally, synchronously or offset in time to the filling of at least one upper lock-hopper, the connecting line between at least one lower lock-hopper (30) and the solid product storage hopper (31) is opened and at least one lower lock-hopper is emptied to the solid product collection hopper.

Therefore (see FIG. 1), the following connections are favorably shut off:
the connecting lines between the reaction chamber and the at least one upper lock-hopper (22),
the connecting lines between the reaction chamber and the at least one lower lock-hopper (32),
the inlet and the recirculation lines connecting the at least one lock-hopper and the purge gas storage tank (51a, 51b),
the connecting lines between the at least one lock-hopper and the purge gas circuit (71a, 71b),
the equalization lines between the head spaces of the reaction chamber and the at least one lock-hopper (52a, 52b),
   and the following connections are favorably be open:
the connecting line between the carrier storage hopper and at least one upper lock-hopper (23),
the connecting line between the product collection hopper and at least one lower lock-hopper (33)

At the end of the step (i) at least one of the upper lock-hoppers (20) is filled with solid granular material and optionally at least one of the lower lock-hoppers (30) is emptied. The filling level of at least one of the upper lock-hoppers filled in step (i) is favorably 10% to 100% of its volumetric capacity, preferably 20% to 100% of its volumetric capacity, more preferably 50% to 100% of its volumetric capacity. The pressure difference between the carrier storage hopper (21) and at least one upper lock-hopper (20) is favorably −10 mbar to 10 mbar, preferably −1 mbar to 1 mbar, more preferably the pressure of the carrier storage hopper and at least one upper lock-hopper is equal. The relative difference of the oxygen concentration in the carrier storage hopper (21), typically ambient atmosphere, and in at least one upper lock-hopper (20) is −10% to 10%, preferably −1% to 1%, more preferably the composition of the gas phases in the carrier storage hopper (21) and in at least upper lock-hopper (20) are identical.

The filling level of at least one lower lock-hopper (30) is favorably 0% to 70%, preferably 0% to 50% of its volumetric capacity, more preferably 0% to 20% of its volumetric capacity. The pressure difference between the product collection hopper (31) and at least one lower lock-hopper (30) is favorably less than 10 mbar, preferably less than 1 mbar, more preferably the pressure of the product collection hopper and at least one lower lock-hopper is equal. The oxygen concentration of the gas phase in the product collection hopper, typically ambient atmosphere, and at least one lower lock-hopper varies favorably by less than 10%, preferably by less than 1%, more preferably the composition of the gas phases in the carrier storage hopper and in the lower lock-hopper are identical.

As the carrier storage hopper (21) and the product collection hopper (31) are exposed to the ambient atmosphere, oxygen enters the lock-hoppers during step (i). Advantageously, a breakthrough of the oxygen into the reaction chamber is prevented (see step (ii)).

Method Step (ii):

In the second step, at least one lock-hopper, preferably all lock-hoppers (20, 30), are purged with purge gas. At least part of the purge gas is recirculated in a purge gas circuit fed from a purge gas storage tank (50).

Preferably, the effluent gas comprising a high concentration of oxygen is discharged in a first step (ii-a) and the purge gas comprising only a low concentration of oxygen gas is recirculated in a purge gas circuit fed from a purge gas storage tank in a second step (ii-b).

Therefore (see FIG. 2), the following connections are favorably shut off:
the connecting line between the carrier storage hopper and at least one upper lock-hopper (23),
the connecting line between the product collection hopper and at least one lower lock-hopper (33),
the connecting lines between the reaction chamber and the at least one upper lock-hopper (22),
the connecting lines between the reaction chamber and the at least one upper lock-hopper (32),
the connecting lines between the at least one lock-hopper and the purge gas circuit (71a, 71b),
the equalization lines between the head spaces of the reaction chamber and the at least one lock-hopper (52a, 52b),
   and the following connections are favorably be open:
the inlet lines connecting the purge gas storage tank and the lock-hoppers (51a, 51b),
during step ii-a: the shutoff valve in the connecting lines between lock-hoppers and exhaust aftertreatment unit (66) or
during step ii-b: the shutoff valve in the recirculation line connecting at least one lock-hopper and the purge tank (64).

Advantageously, the purge gas is circulated between a storage tank (50) and the at least one upper (20) and the at least one lower lock-hopper (30) for purging the lock-hoppers. The absolute pressure in the lock-hopper (20, 30) during step (ii) is favorably 0.1 bar to 10 bar, preferably 0.5 bar to 5 bar, more preferably 0.7 bar to 2 bar.

Advantageously, a partial flow of the purge gas is discharged in a concentration-controlled manner; preferably in a first step (ii-a). The reference variable for controlling the discharge flow is favorable the oxygen concentration in the recirculation line. Advantageously, the oxygen sensor is positioned next to the junction between the lock-hopper and the recirculation line (65). The threshold value for activating discharge is favorable 1 vol % O2 to 20 vol %, preferably 2 vol % O2 to 15 vol % O2, more preferably 3 vol % O2 to 10 vol % O2. Thus, the mode of operation is preferably switched from (ii-a) to (ii-b) as the oxygen concentration in the purge line falls below 1 vol % O2 to 20 vol %, preferably below 2 vol % O2 to 15 vol % O2, more preferably below 3 vol % O2 to 10 vol % O2. The implementation of the control loop is known to persons skilled in the art.

The discharged gas is favorable replaced by make-up purge gas, that is added to the purge gas circuit in a pressure-controlled manner (62, 63). The reference variable for controlling the addition of make-up gas is favorable the pressure in the purge gas storage tank. The setpoint of the pressure in the purge gas storage tank is favorable 1.5 bar to 200 bar, preferably 2 bar to 50 bar, more preferably 3 bar to 10 bar. The implementation of the control loop is known to persons skilled in the art.

The total amount of gas replaced during step (ii) is favorable 1% to 90% of the total capacity of the purge gas storage tank, preferably 5% to 70% of the total capacity of the purge gas storage tank, more preferably 10% to 50% of the total capacity of the purging tank storage tank. Advantageously, the purge gas is conducted through the lock-hoppers by circulation pumps, so that the gas volume of the lock-hoppers is exchanged several times, preferably 1 to 50 times, more preferably 2 to 20 times, even more preferably 3 to 10 times. The content of the purge gas storage tank is favorable recirculated once per 10 executions of step (ii) to 10 times per execution of step (ii), preferably once per five executions of step (ii) to 5 times per execution of step (ii), more preferably once per 3 executions of step (ii) to 3 times per execution of step (ii).

Preferably a purge gas or a purge gas mixture is used as purge gas. The purge gas contains preferably nitrogen and/or helium, argon, carbon dioxide, steam, more preferably nitrogen. The concentration of oxygen in the purge gas storage is preferably in the range 0.1 vol % to 10 vol %, more preferably 0.2 vol % to 5 vol %, even more preferably 0.3 vol % to 3 vol %. Thus, by means of step (ii) ambient oxygen is flushed out of the lock-hoppers.

The different upper and/or lower lock-hoppers can be advantageously connected to a common purge gas circuit.

Method Step (iii):

In the third step, the reaction chamber (10) is filled with granular material from at least one upper lock-hopper (20) and optionally granular material from the reaction chamber is emptied into at least one lower lock-hopper (30), whereas filling granular material into and emptying granular material from the reaction chamber (10) is conducted synchronously or offset in time.

The amounts of solid filled into the reaction chamber and emptied from the reaction chamber vary depending on the amount of matter subject to phase transfer due to chemical reactions conducted in the reaction chamber.

The advantage of a synchronous operation is the simple controlling and the constant hold-up; the advantage of an offset operation is a reduced required amount of purge gas.

Pressure equalization between the reaction chamber and the lock-hoppers is achieved with gas taken from the head space of the reactor chamber (203a, 203b), whereas the pressure equalization is conducted synchronously or offset in time to the filling/emptying.

Therefore (see FIG. 3), the following connections are favorable shut off:
the connecting lines between the carrier storage hopper and the at least one upper lock-hopper (23),
the connecting lines between the product collection hopper and the at least one lower lock-hopper (33),
the inlet and the recirculation lines connecting the at least one lock-hopper and the purge gas storage tank (51b, 51b),
the connecting lines between the at least one lock-hopper and the exhaust gas purge gas circuit (71a, 71b),
   and the following connections are favorably open:
the connecting line between the reaction chamber and at least one upper/lower lock-hopper (22, 32),
the equalization lines between the head spaces, typically not filled with solids, of the reaction chamber and at least one upper/lower lock-hopper (52a, 52b).

Preferably, the pressure equalization between the reaction chamber (10) and at least one upper/lower lock-hopper (20, 30) is achieved with gas from the reaction chamber.

Preferably, the pressure equalization between at least one upper lock-hopper (20) and the reactor chamber (10) is conducted before the solid slide valves (22) between the lock-hopper and the reaction chamber are opened for filling the granular material into the reaction chamber. Similarly, the pressure equalization between at least one lower lock-hopper (30) and the reactor chamber (10) is preferably conducted before the solid slide valves (32) between the reaction chamber and the lower lock-hopper are opened for emptying the granular material from the reaction (also named “solid transfer”). This is accomplished favorable by opening the equalization lines prior to opening the connection lines between the lock-hoppers and the reaction chamber. The time shift between the two actions is favorable 0.1 second than 100 seconds, preferably 0.1 second to 30 seconds, more preferably 0.1 second to 10 seconds. The absolute pressure in the lock-hoppers during step (iii) is favorable 0.1 bar to 100 bar, preferably 0.5 bar to 50 bar, more preferably 1 bar to 25 bar. Advantageously, the flow velocity of the gas flowing through the equalization lines (203a, 203b) is restricted by a restrictor facility, advantageously an orifice plate, a throttle valve, a throttle flap. Preferably, the throttle fitting is controllable. The gas flow velocity in the equalization lines (203a, 203b) during the pressure equalization is favorable less than 200 m/s, preferably less than 100 m/s, more preferably less 50 m/s, most preferably less than 20 m/s. The gas flow velocity in the equalization lines (203a, 203b) during the pressure equalization is favorable 1 cm/s to 200 m/s, preferably 1 cm/s to 100 m/s, more preferably 1 cm/s to 50 m/s, most preferably 1 cm/s to 20 m/s.

Advantageously, the throughput of the granular material from at least one upper lock-hopper (20) to the reaction chamber (10) and from the reaction chamber to at least one lower lock-hopper (30) is controlled via a feeding device (24, 34), preferably a rotary valve or a screw feeder. The reference variable for controlling the solid throughput rate from the upper lock-hopper to the reaction chamber and from the reaction chamber to the lower lock-hopper is preferably the throughput of the granular material in the reaction chamber, or another process related variable, e.g. the gas loading in the reaction chamber or the filling level of the granular material in the reaction chamber or the temperature in the reaction camber. Preferably, the reference variable for controlling the throughput of granular material from at least one upper lock-hopper and the reaction chamber is the filling level of the reaction chamber. Preferably, the reference variable for controlling the throughput of granular material from the reaction chamber to at least one lower lock-hopper and is preferably the temperature in the reaction chamber.

The throughput rate of granular material during step (iii) is favorable 100 g/h to 500 tn/h, preferably 200 g/h to 200 tn/h, more preferably 500 g/h to 100 tn/h, most preferably 1000 g/h to 50 tn/h.

In closing step (iii) the filling level in the at least one upper lock-hoppers (20) is favorable less than 70% of their volumetric capacity, preferably less than 50% of their volumetric capacity, more preferably less than 30% of their volumetric capacity. In closing step (iii) the filling level in the at least one upper lock-hoppers is favorable 0% to 70% of their volumetric capacity, preferably 0% to 50% of their volumetric capacity, more preferably 0% to 30% of their volumetric capacity.

In closing step (iii) the filling level in the at least one of the lower lock-hoppers (30) is favorably 10% to 100% of its volumetric capacity, preferably 20% to 100% of its volumetric capacity, more preferably 50% to 100% of its volumetric capacity.

In closing step (iii) the pressure difference between the head space of the reaction chamber (10) and at least one upper lock-hopper (20) is favorably −10 mbar to 10 mbar, preferably −1 mbar to 1 mbar, more preferably the pressure the head space of the reaction chamber and at least one upper lock-hopper is equal. The relative difference of the concentration of flammable components in the product gas contained in the head space of the reaction chamber (10) and in at least one upper lock-hopper (20) is −10% to 10%, preferably −1% to 1%, more preferably the composition of the gas phases in the head space of the reaction chamber (10) and in at least upper lock-hopper (20) are identical.

In closing step (iii) the pressure difference between the head space of the reaction chamber (10) and at least one lower lock-hopper (30) is favorably −10 mbar to 10 mbar, preferably −1 mbar to 1 mbar, more preferably the pressure the head space of the reaction chamber and at least one lower lock-hopper is equal. The relative difference of the concentration of flammable components in the product gas contained in the head space of the reaction chamber (10) and in at least one lower lock-hopper (30) is −10% to 10%, preferably −1% to 1%, more preferably the composition of the gas phases in the head space of the reaction chamber (10) and in at least lower lock-hopper (30) are identical.

The method step (iii) optionally includes a continuous recirculation of granular material particles from the bottom of the reaction chamber to the top of the reaction chamber. This is done by removing granular material from a lower product hopper (30) and adding granular material to an upper carrier hopper (20) by a facility of recycling granular material (106). The upper carrier hopper (102) and the lower product hopper (103) are preferably permanently connected to the reaction section (101) to secure a continuous granular material flow.

The product gas contained in the head space of the reaction chamber comprises one or more of the flammable component: hydrogen, carbon monoxide, alkanes, alkenes, alkynes, aromatic hydrocarbons, alcohols, aldehydes, ketones, ethers.

Preferred processes and thus preferred product gases are described below.

Method Step (iv):

Optionally, the step (iv) is conducted. The operation of step (iv) is preferable, if the absolute pressure of the reaction chamber is in the range of 1.5 bar to 100 bar, preferably 1.5 bar to 50 bar, more preferably 1.5 bar to 25 bar.

In the method step (iv), the pressure is relieved from the lock-hoppers (20, 30) and conveyed into the product line (206). The main product line (206a) connects the gas outlet of the reaction chamber with downstream units, where the crude product gas is processed further, e.g. a gas purification unit. Each one of the lock-hoppers is connected via a connecting line (201a, 201b and 206b) with the main product line.

Therefore (see FIG. 4), the following connections are favorable shut off:
the connecting lines between the carrier storage hopper and the at least one upper lock-hopper (23),
the connecting lines between the product collection hopper and the at least one lower lock-hopper (33),
the connecting lines between the reaction chamber and the at least one upper lock-hopper (22),
the connecting lines between the reaction chamber and the at least one lower lock-hopper (32),
the inlet lines and recirculation lines connecting the at least one lock-hoppers and the purge gas storage tank (51a, 51b),
   and the following connections are favorably open:
the connecting line between at least one lock-hoppers and the purge gas circuit (71a, 71b).

Due to the present invention the product gas contained in the lock-hopers is made useful at high concentration. The absolute pressure in the lock-hoppers is favorable 0.1 bar to 100 bar, preferably 1 bar to 50 bar, more preferably 1 bar to 25 bar. Optionally, the gas stream is charged to the product line via a compressor (70). The lock-hoppers are favorable partially evacuated. The absolute pressure in the lock-hoppers at the end of step (iv) is favorable 0.1 bar to 10 bar, preferably 0.3 to 5 bar, more preferably 0.7 bar to 2 bar.

Method Step (v):

In the fifth step the lock-hoppers (20, 30) are flushed with purge gas and the product/purge gas is flushed into the product line or discharged to the ambient, preferable via an exhaust gas aftertreatment unit (55) and/or at least part of the purge gas is recirculated in a purge gas circuit fed from a purge gas storage tank (50).

Preferably, the purging gas comprising a high concentration of product gas is flushed into the product line (206) or discharged to the ambient, preferably via an exhaust gas aftertreatment unit (55), in a first step (v-a) and the purge gas comprising only a low concentration of product gas is recirculated in a purge gas circuit fed from a purge gas storage tank in a second step (v-b). This is accomplished by the switching valves (71a, 71b). The reference variable for switching among the steps (v-a) and (v-b) is favorably the concentration of flammable components in the product stream in the product line or in the recirculation line in the purge gas circuit (201), e.g. hydrogen. Advantageously the gas analyzer detecting flammable components is positioned in the product line (67) and/or in the recirculation line in the purge gas circuit (65). The mode of operation is switched from (v-a) to (v-b) as the concentration of flammable components in the product stream in the product line or in the recirculation line in the purge gas circuit (201) falls below 5% to 90% of the lower flammability limit, preferably below 10% to 70% of the lower flammability limit, more preferably below 15% to 50% of the lower flammability limit, whereas the lower flammability limit is determined according to DIN 151649. For example, if hydrogen the main component of the product stream, the mode of operation is switched from (v-a) to (v-b) if the hydrogen concentration falls below 0.2 vol % to 4 vol % hydrogen, preferably 0.5 vol % to 3 vol % hydrogen, more preferably 0.8 vol % to 2 vol %. The implementation of the control loop is known to persons skilled in the art.

Therefore (see FIG. 5), the following connections are favorable shut off:
the connecting lines between the carrier storage hopper and the at least one upper lock-hopper (23),
the connecting lines between the product collection hopper and the at least one lower lock-hopper (33),
the connecting lines between the reaction chamber and the at least one upper lock-hopper (22),
the connecting lines between the reaction chamber and the at least one lower lock-hopper (32),
during step (v-a): the recirculation lines connecting the at least one lock-hopper and the purge gas storage tank (64) or
during step (v-b): the shutoff valve in the connecting lines between the at least one lock-hopper and the exhaust aftertreatment unit (66) and the connecting lines between the at least one lock-hopper and the product line (68),
the equalization lines between the head spaces of the reaction chamber and the at least one lock-hopper (52a, 52b),
   and the following connections are favorably open:
the inlet line connecting at least one lock-hopper and the purge gas storage tank (51a, 51b),
the connecting lines between at least one lock-hopper and the purge gas circuit (71a, 71b),
during step (v-a): the shutoff valve in the connecting lines between the at least one lock-hopper and the exhaust aftertreatment unit (66) and/or the connecting lines between the at least one lock-hopper and the product line (68) or
during step (v-b): the shutoff valve in the recirculation lines connecting the at least one lock-hopper and the purge gas storage tank (64).

During the method step (v) the gas volume of the lock-hoppers is favorable exchanged several times, preferably 1 to 50 times, more preferably 2 to 20 times, even more preferably 3 to 10 times.

The discharged gas is favorable replaced by make-up purge gas, that is added to the purge gas circuit in a pressure-controlled manner (62, 63). The reference variable for controlling the addition of make-up gas is the pressure in the purge gas storage tank (63). The setpoint of the pressure in the purge gas storage tank is favorable 1.5 bar to 200 bar, preferably 2 bar to 50 bar, more preferably 3 bar to 10 bar. The implementation of the control loop is known to persons skilled in the art.

The absolute pressure in the lock-hopper during step (v) is favorable controlled by means of a restrictor facility in the inlet lines connecting the lock-hoppers (20, 30) and the purge gas storage tank (50). The set point is favorable 0.1 bar to 10 bar, preferably 0.3 bar to 5 bar, more preferably 0.7 bar to 2 bar.

Reaction Chamber and Reaction Section:

Advantageously, the reaction chamber (10) comprises a reaction section (101) where the fluid and/or the granular material packing form a continuous stream (see FIGS. 6-8).

The volume of the reaction section is preferably 0.01 m³ to 1000 m³, preferably 0.1 m³ to 10 m³, more preferably 0.5 m³ to 50 m³. The height of the reaction section is preferably 0.1 m to 50 m, preferably 0.5 to 20 m, more preferably 1 m to 10 m.

The packing may favorable be homogeneous or structured over its height. A homogeneous bed may advantageously be a fixed bed, a descending moving bed or a fluidized bed, especially a descending moving bed. A bed structured over its height is advantageously a fixed bed in the lower section and a fluidized bed in the upper section. Alternatively, the structured bed is advantageously a moving bed in the lower section and a fluidized bed in the upper section.

The throughput of the granular material through the reaction section is 0.1 kg/min to 10000 kg/min, preferably from 0.5 kg/min to 5000 kg/min, more preferably 1 kg/min to 1000 kg/min, most preferably 10 kg/min to 100 kg/min. The ratio of the heat capacities of the descending granular flow to the ascending gas flow in the reaction section is 0.1 to 10, preferably 0.5 to 2, more preferably 0.75 to 1.5, most preferably 0.85 to 1.2. This ensures the preconditions of an efficient heat integrated operation of the reactor. The effectiveness factor of internal heat recovery is 50% to 99.5%, preferably 60% to 99%, more preferably 65% to 98%.

Optionally, this section comprises build-ins, e.g. electrodes for conducting electrical current to the packing of the moving bed for supplying joule heating to the process.

Optionally, the reaction chamber may be divided in sections connected via transfer lines. Preferably, the reaction chamber is divided into three sections arranged in one vertical line to each other:
1. Upper section (102) comprising a storage capacity for granular material particles, fed to the reaction chamber (upper carrier hopper),
2. Middle section (101) comprising the descending moving bed stage, preferably moving bed stage, in a reaction section (reaction section),
3. Lower section (103) comprising a storage capacity for granular material particles leaving the reaction chamber (lower product hopper).

Optionally, the reaction chamber comprises an internal recirculation loop (106) conveying granular material particles from the bottom of the reaction chamber to the top of the reaction chamber. The average over time ratio of the mass flow of the recirculated granular material inside the reaction chamber to the mass flow of the mass flow of the granular material inserted to the reaction camber via the lock-hopper is 0 to 50, preferably 0.1 to 10, more preferably 0.2 to 5.

Granular Material:

The granular materials of the production bed are advantageously thermally stable within the range from 500 to 2000° C., preferably 1000 to 1800° C., further preferably 1300 to 1800° C., more preferably 1500 to 1800° C., especially 1600 to 1800° C.

The granular materials of the production bed are advantageously electrically conductive within the range between 10⁻² S/cm and 10⁵ S/cm.

Useful thermally stable granular materials, especially for methane pyrolysis, advantageously include carbonaceous materials, e.g. coke, silicon carbide and boron carbide. A carbonaceous granular material in the present invention is understood to mean a material that advantageously consists of solid grains having at least 50% by weight, preferably at least 80% by weight, further preferably at least 90% by weight, of carbon, especially at least 90% by weight of carbon. Optionally, the granular materials have been coated with catalytic materials. These heat carrier materials may have a different expandability compared with the carbon deposited thereon.

The granule particles have a regular and/or irregular geometric shape. Regular-shaped particles are advantageously spherical or cylindrical.

The granules advantageously have a grain size, i.e. an equivalent diameter determinable by sieving with a particular mesh size, of 0.05 to 100 mm, preferably 0.1 to 50 mm, further preferably 0.2 to 10 mm, especially 0.5 to 5 mm.

It is possible to use a multitude of different carbonaceous granular materials in the process of the invention. A granular material of this kind may, for example, consist predominantly of charcoal, coke, coke breeze and/or mixtures thereof. In addition, the carbonaceous granular material may comprise 0% to 15% by weight, based on the total mass of the granular material, preferably 0% to 5% by weight, of metal, metal oxide and/or ceramic.

Reactions:

The present invention also includes a method of operating an endothermic reaction in a descending moving bed reactor of flowable granular solids comprising the disclosed method of operating a descending moving bed reactor.

Preference is given to conducting high-pressure endothermic reactions.

In addition, preference is given to conducting the following high-temperature reactions in the descending moving bed reactor:
Preparation of synthesis gas by reforming of hydrocarbons with steam and/or carbon dioxide, coproduction of hydrogen and pyrolysis carbon by the pyrolysis of hydrocarbons. Suitable carrier materials are especially carbonaceous granules, silicon carbide-containing granules, nickel-containing metallic granules. Preferably, the process scheme comprises steps (i), (ii-a), (ii-b), (iii), (iv), (v-a), (v-b).
Preparation of hydrogen cyanide from methane and ammonia or from propane and ammonia. Suitable carrier materials are especially carbonaceous granules. Preferably, the process scheme comprises steps (i), (ii-a), (ii-b), (iii), (iv), (v-a). Preferably, method step (v-b) is omitted to prevent accumulation of the toxic hydrogen cyanide in the purge gas circuit.
Preparation of olefins by steamcracking of hydrocarbons or by cracking of hydrocarbons in the absence of steam. Suitable carrier materials are especially carbonaceous granules, silicon carbide-containing granules. Preferably, the process scheme comprises steps (i), (ii-a), (ii-b), (iii), (iv), (v-a), (v-b).
Coupling of methane to ethylene, acetylene and benzene. Preferably, the process scheme comprises steps (i), (ii-a), (ii-b), (iii), (iv), (v-a), (v-b).
Preparation of olefins by catalytic dehydrogenation of alkanes, for example propylene from propane or butene from butane. Suitable carrier materials are especially silicon carbide-containing granules coated with dehydrogenation catalysts or iron-containing shaped bodies. Preferably, the process scheme comprises steps (i), (ii-a), (ii-b), (iii), (iv), (v-a), (v-b).
Preparation of styrene by catalytic dehydrogenation of ethylbenzene. Suitable carrier materials are especially silicon carbide-containing granules coated with dehydrogenation catalysts or iron-containing shaped bodies. Preferably, the process scheme comprises steps (i), (ii-a), (ii-b), (iii), (v-a). Preferably, method step (iv) is omitted due to the low partial pressure of styrene in the product gas and therefore low amount styrene in the lock-hoppers. Preferably, method step (v-b) is omitted to prevent accumulation of styrene in the purge gas circuit and thus avoiding blockage by styrene polymerization.
Preparation of diolefins by the catalytic dehydrogenation of alkanes or olefins, for example butadiene from butene or from butane. Suitable carrier materials are especially silicon carbide-containing granules coated with dehydrogenation catalysts or iron-containing shaped bodies. Preferably, the process scheme comprises steps (i), (ii-a), (ii-b), (iii), (iv), (v-a). Preferably, method step (v-b) is omitted to prevent e.g. butadiene from contacting oxygen in the purge gas circuit and thus avoiding formation of explosive peroxides and/or hard, voluminous polymers so-called popcorn.
Aldehydes by catalytic dehydrogenation of alcohols, for example anhydrous formaldehyde from methanol. Suitable carrier materials are especially silver-containing granules or silicon carbide-containing granules coated with dehydrogenation catalysts or iron-containing shaped bodies. Preferably, the process scheme comprises steps (i), (ii-a), (ii-b), (iii), (v-a). Preferably, method step (iv) is omitted due to the low partial pressure of aldehydes in the product gas and therefore low amount aldehydes in the lock-hoppers. Preferably, method step (v-b) is omitted to prevent contact of formaldehyde with moisture in the purge gas circuit and thus avoiding blockage due to precipitation of paraformaldehyde.
Preparation of CO by the Boudouard reaction from CO2 and carbon. Suitable carrier materials are especially carbonaceous granules. Preferably, the process scheme comprises steps (i), (ii-a), (ii-b), (iii), (iv), (v-a). Preferably, method step (v-b) is omitted to prevent accumulation of the toxic carbon monoxide in the purge gas circuit.
Preparation of hydrogen and oxygen by catalytic water thermolysis over catalysts. Suitable carrier materials are especially silicon carbide-containing or iron-containing granules coated with a cleavage catalyst, for example a ferrite. Preferably, the process scheme comprises steps (i), (ii-a), (ii-b), (iii), (iv), (v-a), (v-b).
Metallurgical applications:
   direct reduction of metal oxides in metallurgy of iron,
   calcination of magnesite, dolomite, clay, zinc carbonate.
   Preferably, the process scheme comprises steps (i), (ii-a), (ii-b), (iii), (iv), (v-a), (v-b).

Preferably, the gas feed is passed countercurrent to the descending moving bed (see FIG. 1, 205 and described in detail for example in WO 2013/004398 or WO 2019/145279).

Advantage of the Present Invention:

Conducting the granular material transfer of the present invention the raw product is less contaminated by the purge gas than described in the state of the art. In addition, the purge gas consumption and the product loss is minimized by inertizing the lock-hoppers at near atmospheric pressure and recirculating the purge gas. Product gas loss is minimized by using product gas to pressurize the lock-hoppers and by conducting the gas to the product line when relieving the lock-hoppers. Moreover, the formation of flammable gas mixture is excluded by the concentration-controlled recirculation of the purge gas. Moreover, the proper arrangement of the lock-hoppers permits a gravity-driven solids transport and saves entirely the expenses otherwise needed by a carrier gas circuit.

Description of the Apparatus:

The main parts of the apparatus are the pressurized reaction chamber (10), the solids inlet lock-hopper (20) and the solids outlet lock-hopper (30), solids feed tank (21), solids product tank (31) and the purge gas storage tank (50). A gas line provided with valves (52a, 52b) connects the head space of the reaction section and the lock-hoppers. The purge gas line provided with valves (51a, 51b) connects the purge gas storage tank (50) with the lock-hoppers (20,30). Solids slide-gate valves connect the lock-hopper to both, the reaction section and the solid tanks (22, 23, 32, 33).

### DESCRIPTION OF THE FIGURES

| | |
|---|---|
| 10 | Reaction chamber |
| 101 | Reaction section (descending moving bed reactor) |
| 102 | Upper carrier hopper |
| 103 | Lower product hopper |
| 104 | Granular material feeder to reaction section |
| 105 | Granular material feeder from reaction section |
| 106 | Facility (conveyor) for internal granular material |
| | recycle in reaction chamber |
| 20 | Upper lock-hopper for carrier feeding to the reaction |
| | chamber |
| 21 | Carrier storage hopper |
| 22 | Shutoff device in the line from upper lock-hopper |
| | to reaction chamber |
| 23 | Shutoff device in the line from carrier storage |
| | hopper to the upper lock-hopper |
| 24 | Granular material feeder from the upper lock-hopper |
| | to reaction chamber |
| 30 | Lower lock-hopper for product withdrawal from |
| | the reaction chamber |
| 31 | Solid product collection hopper |
| 32 | Shutoff device in the line from reaction chamber |
| | to lower lock-hopper |
| 33 | Shutoff device in the line from lower lock-hopper |
| | to product collection hopper |
| 34 | Product conveyor from reaction chamber to lower |
| | lock-hopper |
| 40 | Sieve device |
| 41 | Packaging device |
| 50 | Purge gas storage tank |
| 51a, b | Switch valve in the inlet line from gas storage |
| | tank to the upper/lower lock-hopper |
| 52a, b | Switch valve in the equalization line between |
| | reaction chamber and the upper/lower lock-hopper |
| 53a, b | Dust filter in the equalization line between |
| | reaction chamber and the upper/lower lock-hopper |
| 55 | Exhaust gas aftertreatment unit |
| 60 | Recirculation pump in the recirculation line |
| | from the lock-hoppers to the gas storage tank |
| 61 | Dust filter in the recirculation line from the |
| | lock-hoppers to the gas storage tank |
| 62 | Control valve for pressure controlled purge gas |
| | addition to the gas storage tank |
| 63 | Pressure transmitter |
| 64 | Shutoff device in the recirculation line from the |
| | lock-hopper to the purge gas tank |
| 65 | Gas analyzer in the recirculation line from the |
| | lock-hopper to the purge gas tank |
| 66 | Shutoff device in the connecting lines between |
| | lock-hoppers and exhaust after-treatment unit |
| 67 | Gas analyzer in the connection line between |
| | lock-hoppers and product line |
| 68 | Shutoff device in the connection line between |
| | lock-hoppers and product line |
| 70 | Compressor for charging gas to the product line |
| 71a, b | Switch valve in the line from the upper/lower |
| | lock-hopper to purge gas circuit |
| 201 | Recirculation line in the purge gas circuit |
| 202a, b | Feed line in the purge gas circuit connecting |
| | the gas storage tank to the upper/lower lock-hopper |
| 203a, b | Equilization line connecting the reaction |
| | chamber with the upper/lower lock-hopper |
| 205 | Gas feed line |
| 206 | Gas product line |
| 206a | Main gas product line coming off the reactor |
| 206b | Secondary product lines connectig the lock-hoppres |
| | with the main gas product line |

FIG. 1: Filling and emptying of the lock-hoppers.

The reaction chamber is under pressure. The solid slide valves (22, 32) between the reaction chamber (10) and the lock-hoppers (20, 30) are closed. The lock-hoppers are pressure relieved and opened to the outside so that solids are filled in the upper lock-hopper (20) and emptied from the lower lock-hopper (30). The valves in the purge gas circuit (51a,b) and (71a,b) are closed.

FIG. 2: Purging of the lock-hoppers.

Both solid slide valves of the lock-hoppers are closed. The valves of the purge gas circuit (51a,b) and (71a,b) are open and the lock-hoppers are purged. The purge gas is recycled by circulation pumps (60). A partial flow of the purge gas is discharged in a concentration-controlled manner via valve (65, 66) and replaced by fresh purge gas in a pressure-controlled manner via valve (62, 63).

FIG. 3: Filling and emptying of the reaction chamber.

The valves of the purge gas circuit (51a,b) and (71a,b) are closed. The solid slide valves between the lock-hoppers and the reaction chamber (22, 32) are open and the reaction chamber is filled with solids from the at least one upper lock-hopper and the reaction chamber is emptied into the lower lock-hopper. The valves (52a, 52b) of the equalization gas line are open and the lock-hoppers are filled with reaction gas.

FIG. 4: Relaxing of lock-hoppers and conveying of the product gas of the lock-hoppers into the product line.

The switch valves (71a, 71b) in the purge gas circuit are open. The shutoff valve in the connection to the production line (68) is open. The purge gas is conveyed to the product line by a compressor (70).

FIG. 5: Purging of the lock-hoppers.

The solid slide valves of the upper lock-hoppers (22, 23) and of the lower lock-hoppers (32, 33) are closed. The valves of the purge gas circuit (51a,b) and (71a,b) are open and the lock-hoppers are purged. The purge gas is recycled by circulation pumps (60). A partial flow of the purge gas is discharged in a concentration-controlled manner to the exhaust gas line (65, 66) or to the product line (67, 68) and replaced by fresh purge gas in a pressure-controlled manner via valve (62, 63).

FIG. 6: Configuration with serial arrangement of the upper lock-hopper (20) with the upper carrier hopper (102) and of the upper lock-hopper (20) with the lower product hopper (103).

FIG. 7: Configuration with parallel arrangement of the upper lock-hopper (20) with the upper carrier hopper (102) and of the upper lock-hopper (20) with the lower product hopper (103).

FIG. 8: Configuration with a pair of lower lock-hoppers (30a,b), omitting the storage hoppers inside the reaction chamber (100).

FIG. 9: Activity pattern of the flow controllers connected to the upper lock-hopper

FIG. 10: Activity pattern of the flow controllers connected to the lower lock-hopper

Key FIG. 9 and FIG. 10:
□: valve closed
▪: valve open
1: valve open to recirculation loop
2: valve open to product line

FIG. 11: Sequence control of the configuration according to FIG. 6 in a synchronous operation of the upper and the lower lock-hopper.

FIG. 12: Sequence control of the configuration according to FIG. 6 in an asynchronous operation of the upper and the lower lock-hopper.

FIG. 13: Sequence control of the configuration according to FIG. 7 in a synchronous operation of the upper and the lower lock-hopper.

FIG. 14: Sequence control of the configuration according to FIG. 7 in an asynchronous operation of the upper and the lower lock-hopper.

FIG. 15: Sequence control of the configuration according to FIG. 8 with a pair of lower lock-hoppers activated in an alternating sequence.

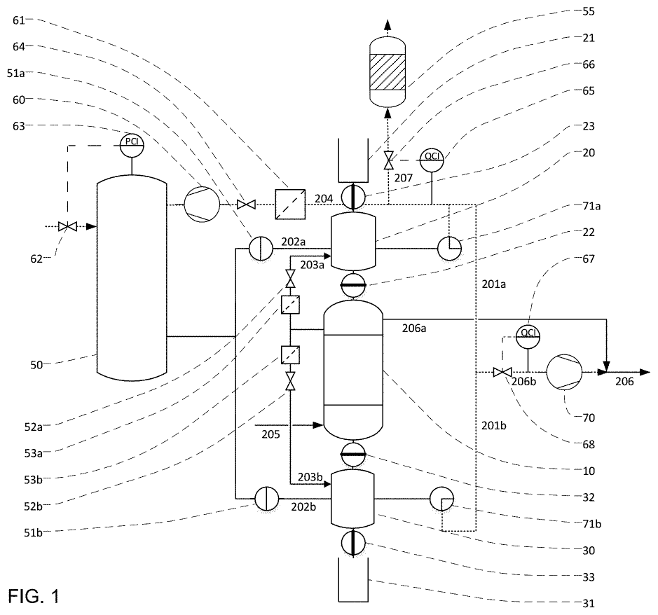

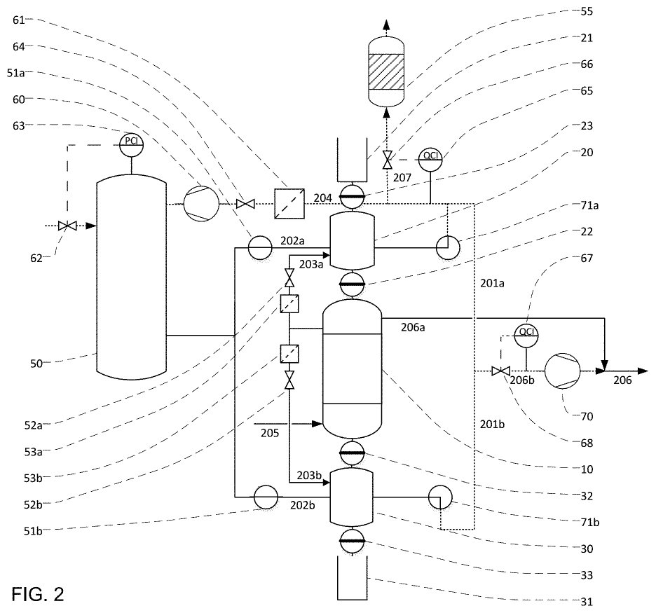

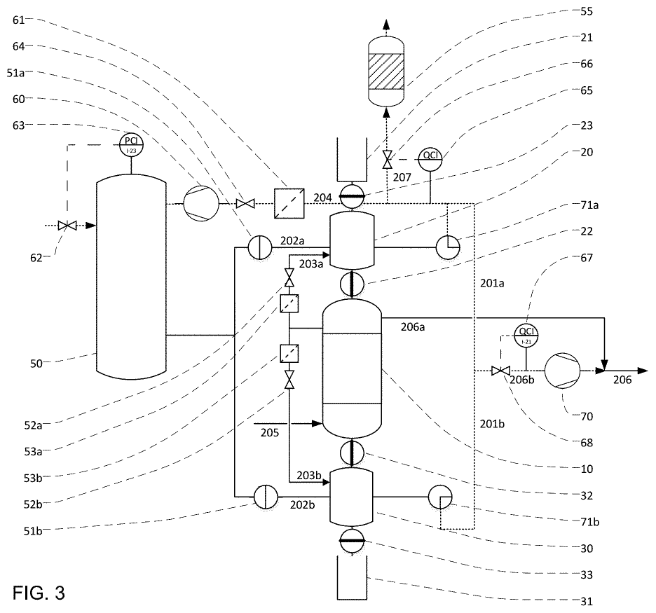

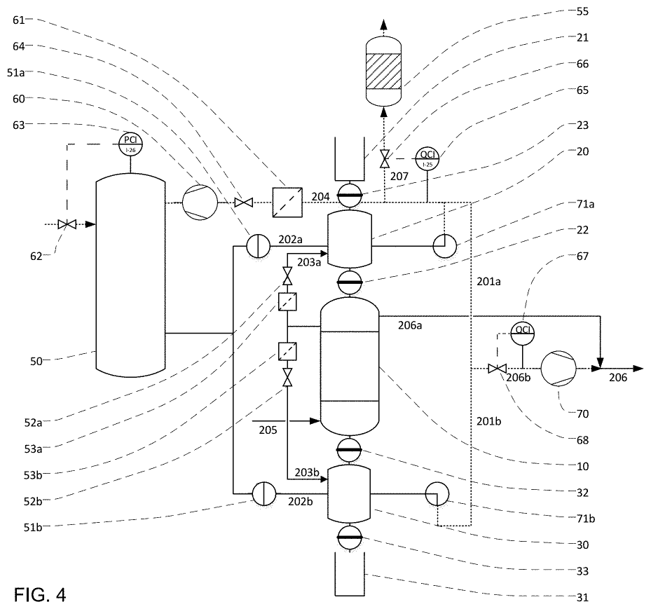

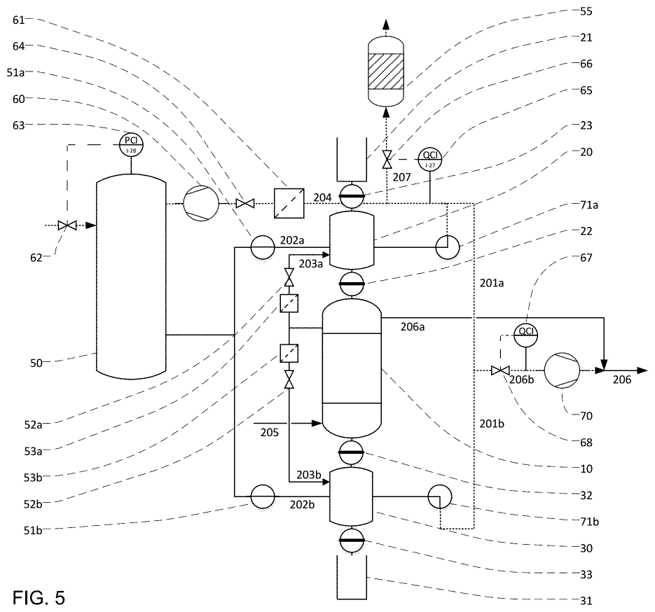

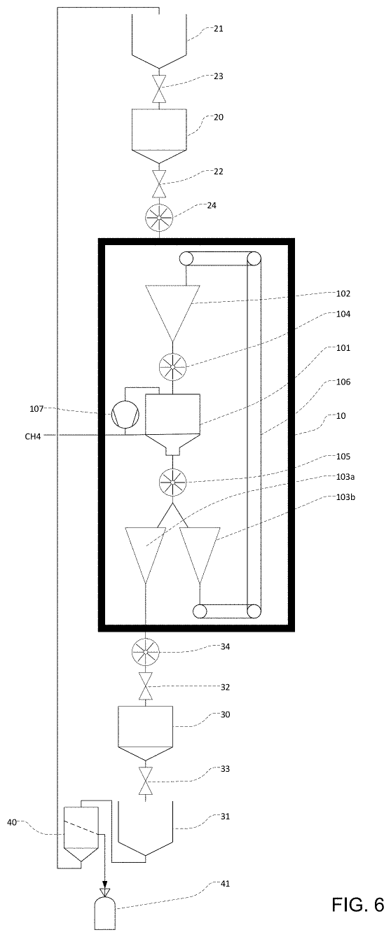

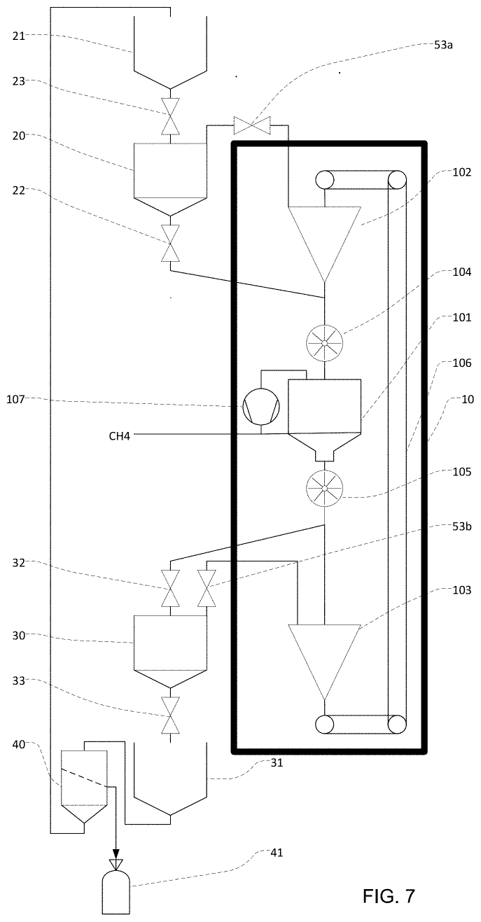

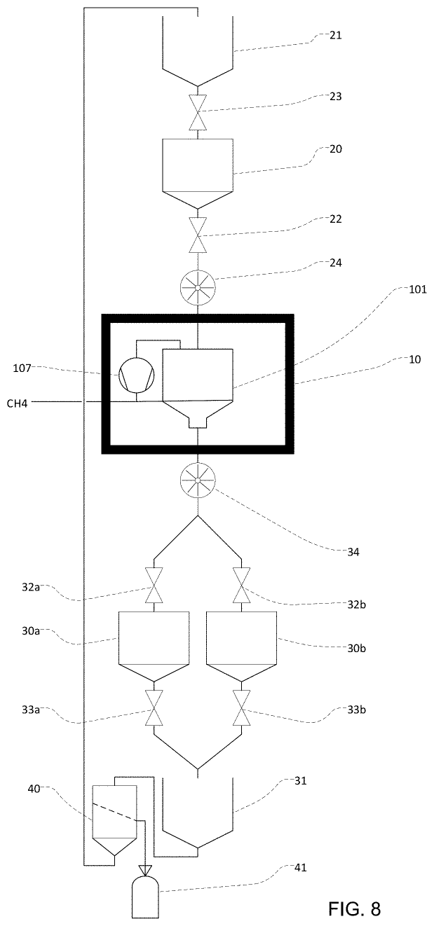

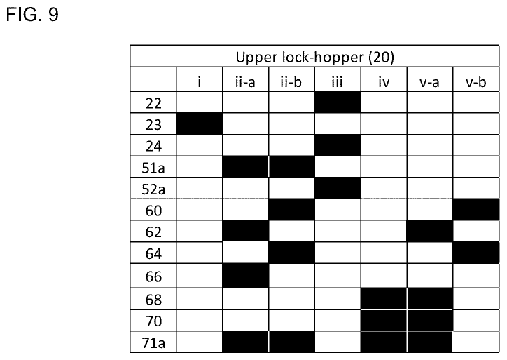

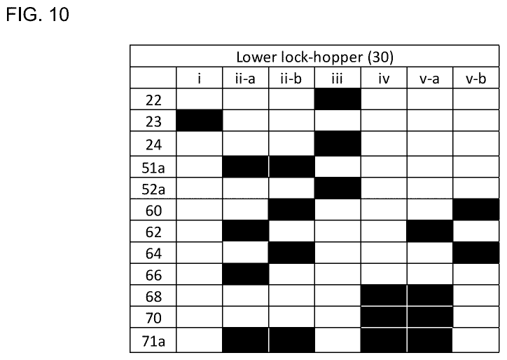

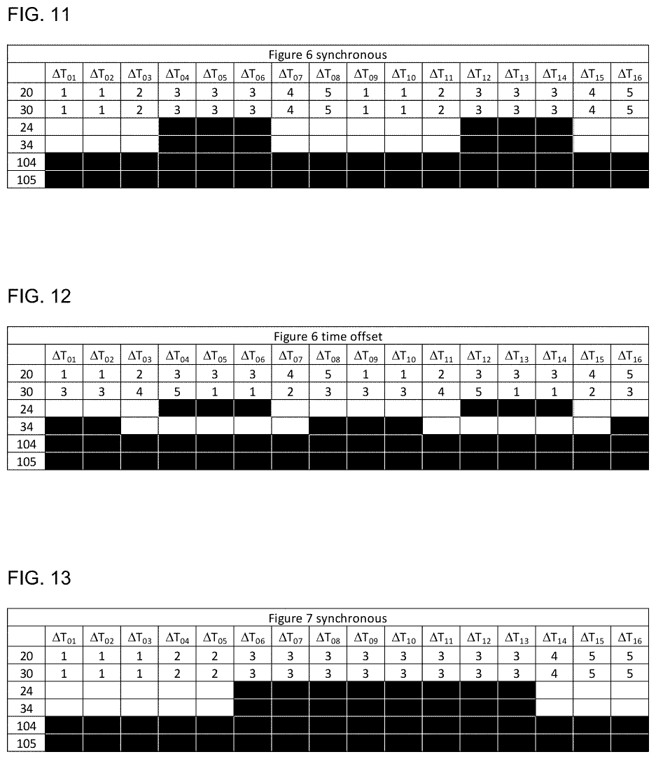

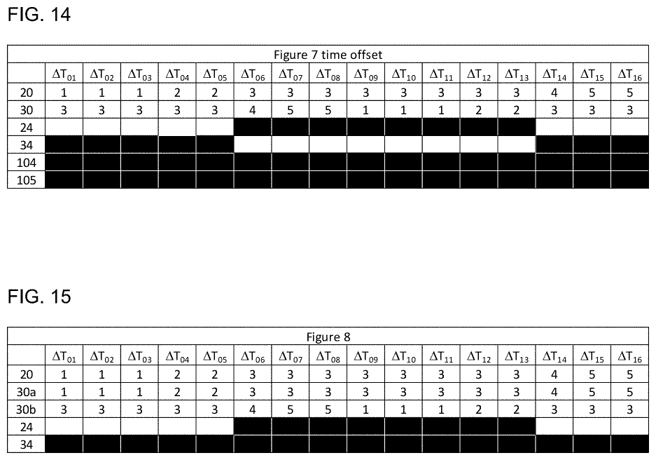

Key FIGS. 11-15
1 to 5: Stages of the operation cycle of the upper and the lower lock-hopper
□: inactive metering feeder of granular material
▪: active metering feeder of granular material

### EXAMPLES

### Reference Example (Following State of the Art CN 106 893 611 A)

Methane pyrolysis in a moving bed reactor is considered. The absolute pressure in the reaction chamber is 10 bar. The production rate of the reactor is 10000 (Nm3 H2)/h. The volumetric gas feed rate is about 31000 Nm3/h. The reactor is filled with 60 m³ of a granular coke carrier. The volumetric feed rate of the solid carrier is 30 m³/h. The volumetric capacity of the upper and the lower lock-hopper is 10 m³ each. The lock-hoppers are filled to a maximum filling level of 80% of their total volume. The carrier storage hopper and the product collection hopper are exposed to the atmosphere. In the state of the art following CN 106 893 611 A the purge gas is utilized as well for inertizing the lock-hoppers as for pressurizing the lock-hoppers. Inertizing means that after purging the lock-hoppers the residual volume ratio of oxygen and the residual volume ratio of hydrogen is lower than 1%. Pressurizing means that the pressure of the lock-hoppers is raised up to the pressure of the reaction camber, i.e. 10 bar absolute pressure. Following the state of the art disclosed in CN 106 893 611 A the exhaust gas streams of the lock-hoppers are not recirculated. Inertizing the lock-hoppers requires 860 Nm3/h of the purging gas nitrogen. Pressurizing the lock-hoppers requires 550 Nm3/h of nitrogen. About 550 Nm3/h of nitrogen is mixed with the product stream, leading additional dilution of the produced hydrogen. The volume of the nitrogen that contaminates the product stream is about 5.5% of the volume of the produced hydrogen. About 420 Nm3/h of the product gas is discharged. This is equivalent to a yield loss of hydrogen about 1.2%.

Example According to Invention:

Methane pyrolysis in a moving bed reactor is considered. The absolute pressure in the reaction chamber is 10 bar. The production rate of the reactor is 10000 (Nm3/h). The volumetric gas feed rate is about 31000 Nm3/h. The reactor is filled with 60 m3 of a granular coke carrier. The volumetric feed rate of the solid carrier is 30 m3/h. The volumetric capacity of the upper and the lower lock-hopper is 10 m³ each. The volumetric capacity of the purge gas storage tank is 20 m³ and the pressure is regulated to 3 bar. The carrier storage hopper and the product collection hopper are exposed to the atmosphere. After feeding the upper lock-hopper respectively emptying the lower lock-hopper the void space of the lock-hoppers contains air. The lock-hoppers are flushed with nitrogen from the purge gas storage tank (step ii). The recycle is activated in a concentration-controlled manner: It is completely closed when the volume ratio of oxygen at the outlet of the lock-hopper is higher than 5% (step ii-a) and it is completely open when the volume ration of oxygen at the outlet of the lock-hopper is less than 4% (step ii-b). Between 4% and 5% the position of the control valve is adjusted proportionally. The discharged amount of gas is replaced by nitrogen fed to the gas storage tank (50). The purge gas consumption is 20 Nm3/h for purging the lock-hoppers to a residual oxygen volume ratio below 1 vol %. During feeding the carrier to the reaction chamber respectively removing solid product from the reaction chamber, the lock-hoppers are filled with almost pure hydrogen at an absolute pressure of 10 bar. Subsequently, the gas hold-up of the lock-hoppers is expanded to 3 bar and conveyed to the product line by means of a compressor (step iv). Following that the lock-hoppers are purged with nitrogen from the gas storage tank (step v). The recycle is activated in a concentration-controlled manner: It is completely closed when the volume ratio of hydrogen at the outlet of the lock-hopper is higher than 3% (step v-a) and it is completely open when the volume ration of hydrogen at the outlet of the lock-hopper is less than 2 vol % (step v-b). Between 2% and 3% the position of the control valve is adjusted proportionally. The discharged amount of gas is replaced by nitrogen fed to the gas storage tank (50). The purge gas consumption is 40 Nm3/h for purging the lock-hoppers to a residual hydrogen volume ratio below 1 vol %. The volume of the nitrogen that contaminates the product stream is about 0.55% of the volume of the produced hydrogen. About 165 Nm3/h of the product gas is discharged. This is equivalent to a yield loss of hydrogen about 0.45%.

Omitting the purge gas storage tank (50) in the present invention implies that purge gas recirculation (steps ii-b and v-b) will be omitted. Accordingly, the gas purge gas consumption becomes 890 Nm3/h.

Omitting the compressor for charging gas to the product line (70) in the present invention implies that product gas contained in the lock-hoppers will be discharged during the expansion of the lock-hoppers (step iv will be omitted). Accordingly, the discharged amount of product gas becomes 610 Nm3/h. This is equivalent to a yield loss of hydrogen about 1.5%.

Comparison:

| | | | | | Present | | | |
|---|---|---|---|---|---|---|---|---|
| | | | | | Invention, | | | |
| | Present | | Present | | including | | | |
| | Invention, | | Invention, | | step (iv), but | | | |
| | including | | but omitting | | omitting steps | | State of | |
| | step (iv) | | step (iv) | | (ii-b) & (v-b) | | the art | |
| Purge gas consumption for | 60 | Nm3/h | 60 | Nm3/h | 880 | Nm3/h | 1410 | Nm3/h |
| purging the lock-hoppers to a | | | | | | | | |
| residual oxygen and hydrogen | | | | | | | | |
| volume ratio below 1% | | | | | | | | |
| Purge gas mixed with the | 55 | Nm3/h | 55 | Nm3/h | 55 | Nm3/h | 550 | Nm3/h |
| product gas | | | | | | | | |
| Discharged product gas | 165 | Nm3/h | 550 | Nm3/h | 165 | Nm3/h | 550 | Nm3/h |

| | | | | |
|---|---|---|---|---|
| Contamination of product | 0.55% | 0.55% | 0.55% | 5.5% |
| stream with purge gas | | | | |
| Product yield loss | 0.45% | 1.5% | 0.45% | 1.2% |

1-15. (canceled)

16: A reactor, comprising:
a carrier storage hopper to deliver feed granular material to at least one upper lock-hopper,
the at least one upper lock-hopper comprising a first inlet shut-off facility and a first outlet shut-off facility,
an upper granular material feeder connected from the at least one upper lock-hopper to a reaction chamber,
the reaction chamber comprising a reaction section and, optionally, at least one upper carrier hopper, at least one lower product hopper, and additional facilities for a granular material recycle,
a lower granular material feeder connected from the reaction chamber to at least one lower lock-hopper,
the at least one lower lock-hopper comprising a second inlet shut-off facility and a second outlet shut-off facility,
a solid product collection hopper,
a recirculation line that is outside the reaction chamber, in fluid communication with the at least one upper lock-hopper, the at least one lower lock-hopper, and a purge gas storage tank permitting circulation of purge gas from the purge gas storage tank to the at least one upper lock-hopper and/or the at least one lower lock-hopper, and back to the purge gas storage tank,
at least one gas analyzer that is connected to a control valve for concentration-controlled gas discharge from a purge gas circuit,
a product line outside the reaction chamber in fluid communication with the at least one upper lock-hopper, the at least one lower lock-hopper, and a main product line that connects a gas outlet of the reaction chamber with downstream units, and
the purge gas storage tank that is connected to the recirculation line.

17: A method for operating a descending bed in the reactor according to claim 16 with flowable granular material, the method comprising:
in the at least one upper lock-hopper:
(i) filling the at least one upper lock-hopper with granular material,
(ii) flushing the at least one upper lock-hopper with the purge gas and recirculating at least part of the purge gas in the purge gas circuit fed from the purge gas storage tank and recirculated to the purge gas storage tank, wherein
(ii-a) a first effluent gas comprising a high concentration of oxygen is discharged, and
(ii-b) a first purge gas comprising a low concentration of oxygen gas is recirculated in the purge gas circuit fed from the purge gas storage tank,
wherein the concentration of oxygen is detected by the at least one gas analyzer,
(iii) filling the reaction chamber, comprising a descending, pre-existing moving bed, with the granular material from the at least one upper lock-hopper, wherein a pressure equalization between the reaction chamber and the at least one upper lock-hopper is achieved with gas taken from a head space of the reactor chamber,
(iv) optionally, relieving pressure of the at least one upper lock-hopper and conveying a product gas flow from the at least one upper lock-hopper into the main product line that connects the gas outlet of the reaction chamber with downstream units, and
(v) flushing the at least one upper lock-hopper with the purge gas and recirculating at least part of the purge gas in the purge gas circuit fed from the purge gas storage tank and recirculated to the purge gas storage tank, and flushing the at least one lock-hopper with purge gas into the product line or discharging an effluent stream; and
in the at least one lower lock-hopper:
(i) emptying the granular material from the at least one lower lock-hopper,
(ii) flushing the at least one lower lock-hopper with purge gas and recirculating at least part of the purge gas in the purge gas circuit fed from the purge gas storage tank and recirculated to the purge gas storage tank, wherein
(iia) a second effluent gas comprising a high concentration of oxygen is discharged, and
(iib) a second purge gas comprising a low concentration of oxygen gas is recirculated in the purge gas circuit fed from the purge gas storage tank,
wherein the concentration of oxygen is detected by the at least one gas analyzer,
(iii) emptying the reaction chamber into the at least one lower lock-hopper, wherein the pressure equalization between the reaction chamber and the at least one lower lock-hopper is achieved with the gas taken from the head space of the reactor chamber,
(iv) optionally, relieving pressure of the at least one lower lock-hopper and conveying the product gas flow from the at least one lower lock-hopper into the main product line that connects the gas outlet of the reaction chamber with downstream units, and
(v) flushing the at least one lower lock-hopper with purge gas and recirculating at least part of the purge gas in the purge gas circuit fed from the purge gas storage tank and recirculated to the purge gas storage tank, and flushing the at least one lock-hopper with purge gas into the product line or discharging the effluent stream;
wherein (i) to (v) in the at least one upper lock-hopper and in the at least one lower lock-hopper are conducted synchronously or offset to each other in time.

18: The method according to claim 17, wherein a cycle period of one operation cycle of the at least one upper lock-hopper is equal to one tenth to ten cycle periods of an operation cycle of the at least one lower lock-hopper.

19: The method according to claim 17, wherein in the at least one upper lock-hopper and the at least one lower lock-hopper, a mode of operation is switched from (ii-a) to (ii-b) as an oxygen concentration in the purge gas circuit falls below 1 vol % O₂ to 20 vol % O₂.

20: The method according to claim 17, wherein the reaction chamber comprises the reaction section and a throughput of the granular material through the reaction section is 0.1 kg/min to 10,000 kg/min.

21: The method according to claim 17, wherein an absolute pressure of the reaction chamber is 0.1 bar to 100 bar.

22: The method according to claim 17, wherein a concentration of oxygen in the purge gas storage tank is in a range of 0.1 vol % to 10 vol %.

23: The method according to claim 17, wherein in the at least one upper lock-hopper and the at least one lower lock-hopper, a gas volume is exchanged 2 to 20 times in (ii) and optionally (iv).

24: The method according to claim 17, wherein in the at least one upper lock-hopper and the at least one lower lock-hopper, (v) comprises (v-a) and (v-b):
(v-a) flushing a purge gas comprising a high concentration of product gas into the product line, and
(v-b) recirculating a purge gas comprising a low concentration of product gas in the purge gas circuit fed from the purge gas storage tank,
wherein a concentration of product gas is detected by a gas analyzer.

25: The method according to claim 24, wherein a mode of operation is switched from (v-a) to (v-b) as a hydrogen concentration in the product line falls below 0.2 vol % to 4 vol %.

26: The method according to claim 17, wherein the reaction chamber comprises at least one upper carrier hopper and at least one lower product hopper connected to the reaction section, and wherein part of the granular material is recirculated from the at least one lower product hopper to the at least one upper carrier hopper.

27: The method according to claim 17, wherein the at least one upper lock-hopper consists of one upper lock-hopper and the at least one lower lock-hopper consists of two lower lock-hoppers, wherein the two lower lock-hoppers are connected in parallel.

28: The method according to claim 17, wherein the reaction chamber comprises a descending moving bed.

29: The method according to claim 17, wherein an endothermic reaction is operated in the reactor chamber.

30: The method according to claim 28, wherein a gas feed is passed countercurrent to the descending moving bed.
